(19) United States
(12) Patent Application Publication
(10) Pub. No.: US 2025/0319621 A1
(43) Pub. Date: Oct. 16, 2025

(54) FOOD PRODUCT SLICER AND ASSOCIATED TRAY ARM TILT LOCKING ASSEMBLY

(71) Applicant: ILLINOIS TOOL WORKS INC., Glenview, IL (US)

(72) Inventor: Matthew W. BIRD, Xenia, OH (US)

(21) Appl. No.: 19/090,719

(22) Filed: Mar. 26, 2025

Related U.S. Application Data
(60) Provisional application No. 63/633,921, filed on Apr. 15, 2024.

(51) Int. Cl. B26D 7/06; B26D 1/143

(52) U.S. Cl. CPC B26D 7/0616; B26D 1/143; B26D 2210/02

(57) ABSTRACT

A food product slicer includes a base, a knife mounted for rotation relative to the base and a carriage assembly mounted to the base for reciprocal movement back and forth past a cutting edge of the knife. The carriage includes a tray atop a tray arm, and the tray arm is pivotably connected to a mount part of a carriage transport. A releasable locking assembly holds the tray arm in an operating position on the mount part and release of the locking assembly enables the tray arm to pivot to a cleaning position. The locking assembly is configured such that, when the tray arm is moved from the cleaning position to the operating position, the tray arm locking assembly automatically locks the tray arm to prevent the tray arm from pivoting from the operating position to the cleaning position.

### TECHNICAL FIELD

This application relates generally to food product slicers of the type commonly used to slice bulk food products and, more specifically, to a tray arm tilt locking assembly in such a food product slicer.

### BACKGROUND

Typical reciprocating food slicers have a rotatable, circular or disc-like slicing blade, an adjustable gauge plate for varying the thickness of the slice and a carriage for supporting the food as it is moved back and forth past the cutting edge of the knife during slicing. A drive motor may be linked to drive the carriage back and forth during an automatic slicing operation carried out by a controller of the slicer. The gauge plate is situated along the edge of the knife toward the front of a slicing stroke and is laterally movable with respect to the knife for varying the thickness of the slices to be cut. A rotatable adjustment or indexing knob is provided for manually setting a spacing between the plane of the gauge plate surface and the plane of the knife edge for the purpose of slicing so that operators can select a thickness of slices to be produced.

Slicer tray arms mount the product holding tray of the carriage to a transport. Many of them allow the product tray to tilt down for easy cleaning. Existing slicer tray arms are usually “tied down” to the transport with a knob/screw. To “unlock” and allow for product tray tilting, the operator must unscrew the bolt, which takes several revolutions. To “lock” the product tray from tilting, the operator must screw the bolt into the transport, which takes several revolutions. The time and additional steps associated with this operation are not beneficial, since this is a critical step to cleaning/sanitizing the machine and the operation may be done many times during the day. The screwing action means that there are 3 stages that the system can take: locked from tilting, unlocked for tilting, or somewhere in between. If the screw is only partially fastened, the product tray won't be completely tied down and can move during slicing.

Accordingly, it would be desirable to provide a slicer with a tray arm tilt lock assembly that is simpler and more intuitive.

### SUMMARY

In one aspect, a food product slicer includes a base, a knife mounted for rotation relative to the base and a carriage assembly mounted to the base for reciprocal movement back and forth past a cutting edge of the knife. The carriage includes a tray atop a tray arm, and the tray arm is pivotably connected to a mount part of a carriage transport. A releasable locking assembly holds the tray arm in an operating position on the mount part and release of the locking assembly enables the tray arm to pivot to a cleaning position. The locking assembly is configured such that, when the tray arm is moved from the cleaning position to the operating position, the tray arm locking assembly automatically locks the tray arm to prevent the tray arm from pivoting from the operating position to the cleaning position.

In another aspect, a food product slicer includes a base, a knife mounted for rotation relative to the base and a carriage assembly mounted to the base for reciprocal movement back and forth past a cutting edge of the knife. The carriage includes a tray atop a tray arm, and the tray arm is pivotably connected to a mount part of a carriage transport. A releasable locking assembly holds the tray arm in an operating position on the mount part and release of the locking assembly enables the tray arm to pivot to a cleaning position. A releasable locking assembly is carried by the tray arm and is configured such that: when the tray arm is in the operating position, the locking assembly prevents the tray arm from pivoting into the cleaning position; and when the tray arm is in the cleaning position, the locking assembly prevents the tray arm from pivoting into the operating position.

In another aspect, a food product slicer includes a base, a knife mounted for rotation relative to the base and a carriage assembly mounted to the base for reciprocal movement back and forth past a cutting edge of the knife. The carriage includes a tray atop a tray arm, and the tray arm is pivotably connected to a mount part of a carriage transport. A releasable locking assembly holds the tray arm in an operating position on the mount part and release of the locking assembly enables the tray arm to pivot to a cleaning position. A releasable locking assembly is carried by the tray arm and is configured to hold the tray arm in the operating position, wherein the locking assembly includes a rotatable knob and a locking component that is biased away from the knob by a spring.

In another aspect, a food product slicer includes a base, a knife mounted for rotation relative to the base and a carriage assembly mounted to the base for reciprocal movement back and forth past a cutting edge of the knife, wherein the carriage includes a tray atop a tray arm, and the tray arm is pivotably connected to a mount part of a carriage transport. A releasably locking assembly holds the tray arm in an operating position on the mount part and release of the locking assembly enables the tray arm to pivot to a cleaning position for the tray arm. In implementations, (i) the locking assembly is configured to automatically lock the tray arm against pivot when the tray arm is moved from the cleaning position to the operating position; and/or (ii) the locking assembly is configured to bias a locking component of the locking assembly into a locking position; and/or (iii) the locking assembly includes a rotatable knob and a knob rotation of no more than 360 degrees shifts a locking component of the locking assembly from a locking position to an unlocked position.

### BRIEF DESCRIPTION OF DRAWINGS

FIGS. 1 and 2 show a food product slicer;

FIGS. 3-4 show views of a tray arm mount;

FIGS. 5-10 show portions of a locking assembly for the tray arm mount;

FIG. 11 shows another embodiment of a plunger of the locking assembly;

FIGS. 12 and 13 show another embodiment of a knob of the locking assembly;

FIG. 14 shows the operating position of the tray arm;

FIG. 15 shows the cleaning position of the tray arm (food product tray not shown);

FIG. 16 shows portions of the tray arm and mount part when the tray arm is in the cleaning position;

FIGS. 17-19 show portions of the tray arm and mount part of another embodiment, when the tray arm is in the operating position;

FIGS. 20-22 show parts of the locking assembly in an exploded condition;

FIGS. 23-24 show the knob;

FIG. 25 shows the locking assembly, with the knob depicted as transparent; and

FIG. 26 shows the tray arm in the cleaning position, with tray arm depicted as transparent.

### DETAILED DESCRIPTION

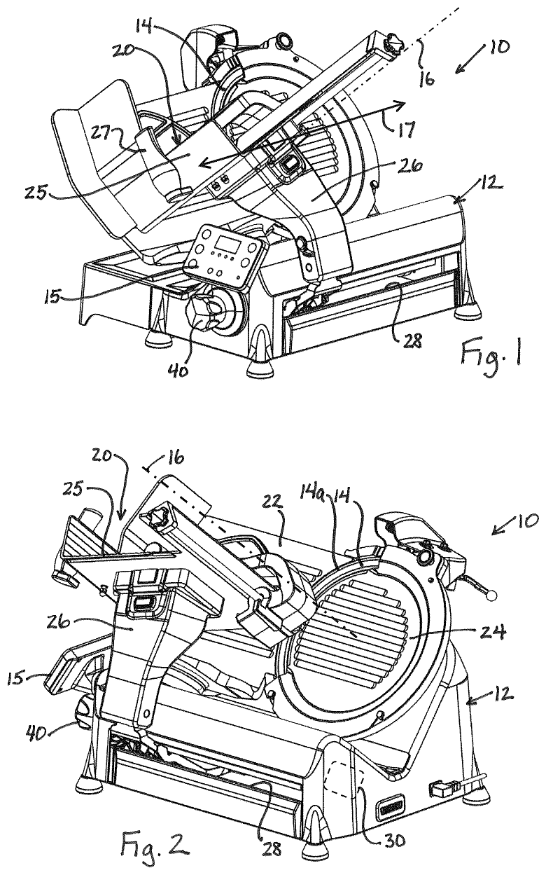

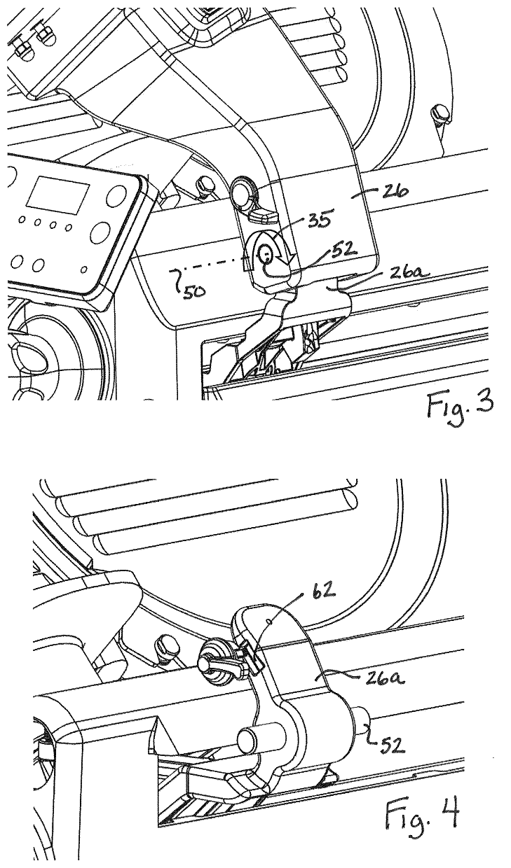

Referring to FIGS. 1-2, a food product slicer 10 includes a base 12 (e.g., housing and/or frame) and a circular, motor-driven slicing knife 14 that is mounted to the housing for rotation about an axis 16. The left side of FIG. 1, where the controls (e.g., user interface 15) are located, is generally referred to as the front side of the slicer (which is where an operator stands for slicing), the right side of FIG. 1 is generally referred to as the rear side of the slicer. A food product can be supported on a manually operable (or motor driven) food carriage 20 which moves the food product to be sliced past the cutting edge 14a of the rotating slicing knife 14. The food carriage 20 reciprocates back and forth along a linear path 17 so that the lower end of the bulk food product slides along the surface of a gauge plate 22, is cut by the knife 14 and then slides along a knife cover plate 24. The food carriage 20 includes a tray 25 mounted on a tray arm 26 that orients the food carriage tray at the appropriate angle (typically perpendicular) to the knife cutting-edge plane. The food carriage arm reciprocates along a slot 28 at a lower portion of the housing 12. The carriage 20 can be moved manually (e.g., by a handle 27) and/or the carriage 20 may also be automatically driven (e.g., as by an internal motor 30 that drives a belt that is linked internally to a transport to which the arm 26 is pivotably connected). A gauge plate system includes a rotatable knob 40 (connected to an opening in the base 12).

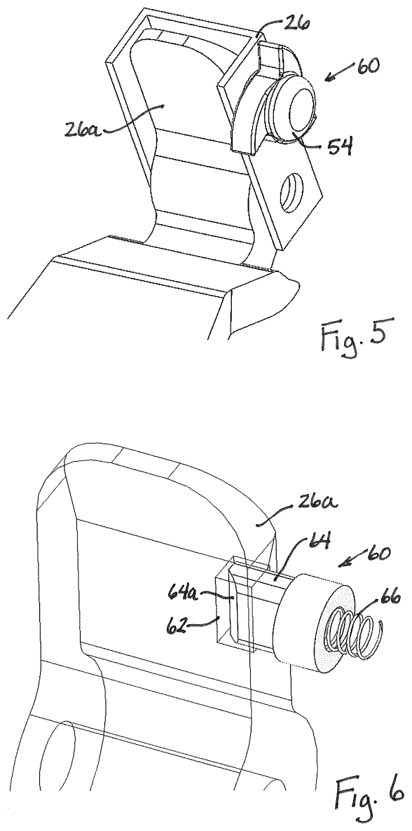

Referring now to FIGS. 3-4, the attachment of the tray arm 26 to a protruding arm mount part 26a of the transport is shown, and includes a pivot axis 50, along pivot pin 52, and about which the tray arm 26 can pivot, out of the illustrated operating position toward a cleaning position outward and away from the gauge plate 22, per arrow 35, for cleaning of the carriage tray. The pivot provides the tilt function. The tray arm 26 includes openings that engage with the pin 52 for this purpose. Above the pivot axis 50, the tray arm 26 locks to the arm part 26a to prevent tilting unless the locking is released. Here, a knob 54 is provided to enable release of the locking function, by rotation of the knob 54, when tilt of the tray arm 26 is desired.

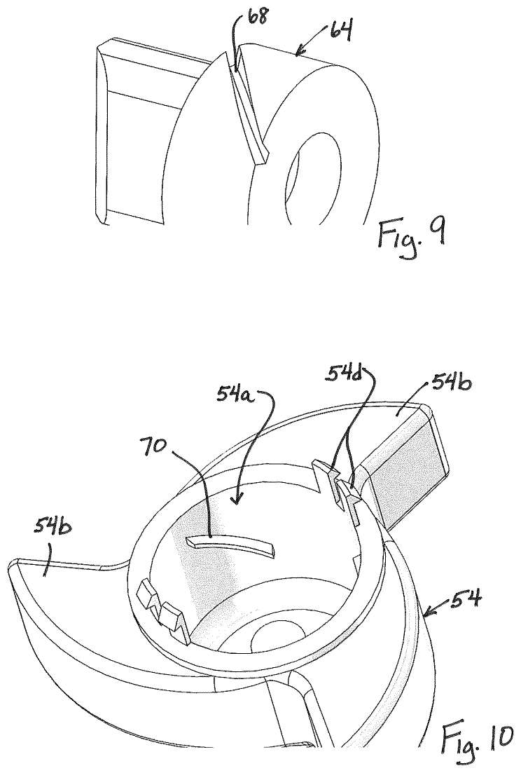

FIGS. 5-10 show details of one embodiment of the locking assembly 60 that is operated by rotation of the knob 54. In particular, the arm mount part 26a includes a side slot or pocket 62 into which a locking component, which here is a locking plunger 64, which extends from a cavity 54a of the knob 54, engages to prevent the tray arm 26 from tilting out of the operating position. The locking plunger is biased toward the slot or pocket by a spring 66. The external surface of the locking plunger 64 includes one or more helical slots 68 that that interact with helical ribs 70 on an internal surface portion of the knob 54. When the knob 54 is rotated, this interaction pulls the locking plunger further into the cavity 54a of the knob 54 so that the locking plunger clears the slot or pocket 62, enabling the tray arm 26 to be pivoted/tilted. The spring 66 is compressed between an internal surface of the cavity 54a of the knob 54 and the locking plunger 64, and therefore release of the knob will automatically result in the locking plunger being moved back to its extended position (and also causes rotation of the knob 54). Therefore, the locking plunger 64 cannot take up and stay in an intermediate position. The locking plunger 62 is always fully extended, unless (i) the knob 54 is held in a rotated position that retracts the locking plunger into the cavity of the knob or (ii) some structure is blocking the ability of the plunger to extend.

The locking plunger 64 may include a tapered cam surface 64a that faces inward relative to the slicer body and engages with a surface of the arm mount part 26a when the tray is tilted from its cleaning position back toward its use or operating position. This interaction of the surfaces creates a reactive force that automatically pushes the locking plunger 64 into the cavity 54a of the knob arm 54, until the inner end of the locking plunger 64 comes into alignment with the slot or pocket 62, at which point the spring bias pushes the locking plunger back outward into the extended and locked position within the slot or pocket 62, preventing tray arm tilt. Thus, an automatic locking/latching is provided by simply pivoting the tray arm 26 back into its use or operating position.

In an alternative embodiment, per FIG. 11, a sleeve 64b that is engaged on the locking plunger 64 includes the helical slots 68, rather than the plunger body itself having the helical slots. This variation reduces friction.

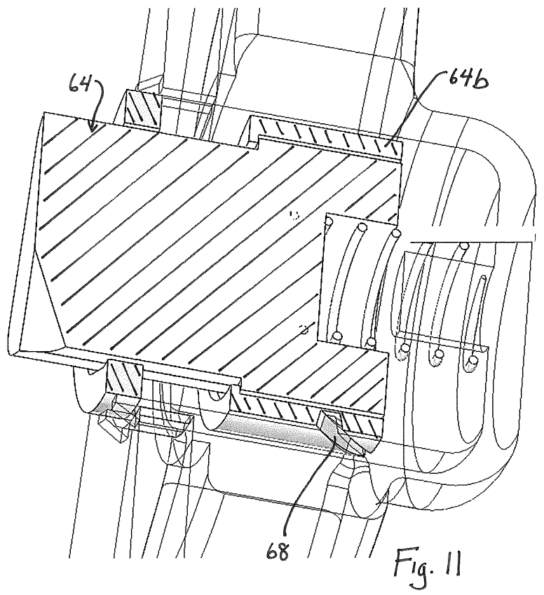

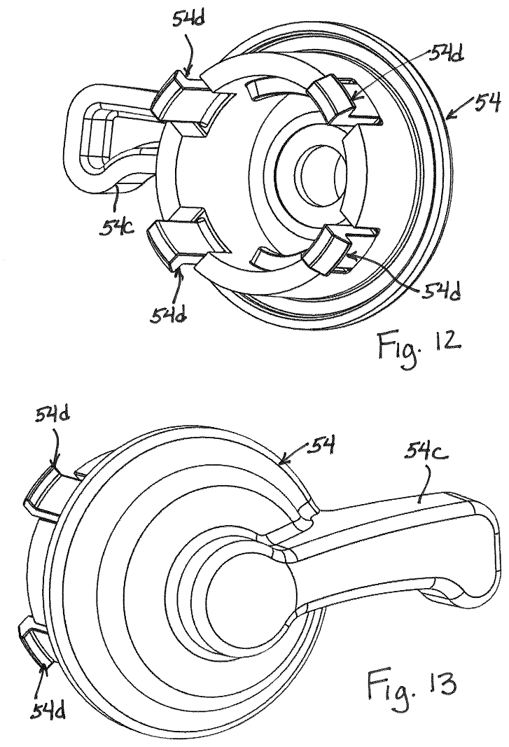

In the knob embodiment shown in FIG. 10, the knob includes multiple arms 54b that are configured to indicate which direction the lever or arm should be rotated for operation. In the knob embodiment of FIGS. 12 and 13, a single arm 54c is provided. In both cases, the inwardly facing axial end of the knob 54 may include set of flexing clip latch fingers 54d that will engage with the opening in the tray arm 26 to retain the knob in place.

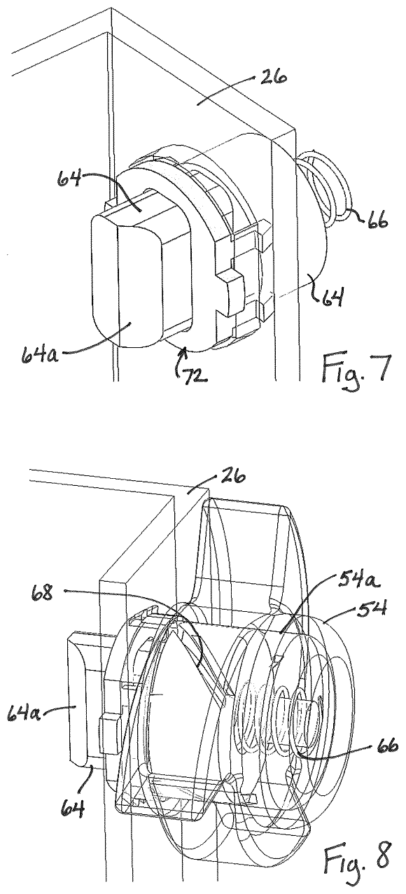

Per FIG. 7, a clip member 72 at the internal side of the tray arm opening may be utilized to provide a keying feature to prevent rotation of the locking plunger relative to the tray arm 26.

In embodiments, the slot or pocket could have features that mate with the plunger to ensure a positive lock and that there is no ‘slop’ or extra clearance.

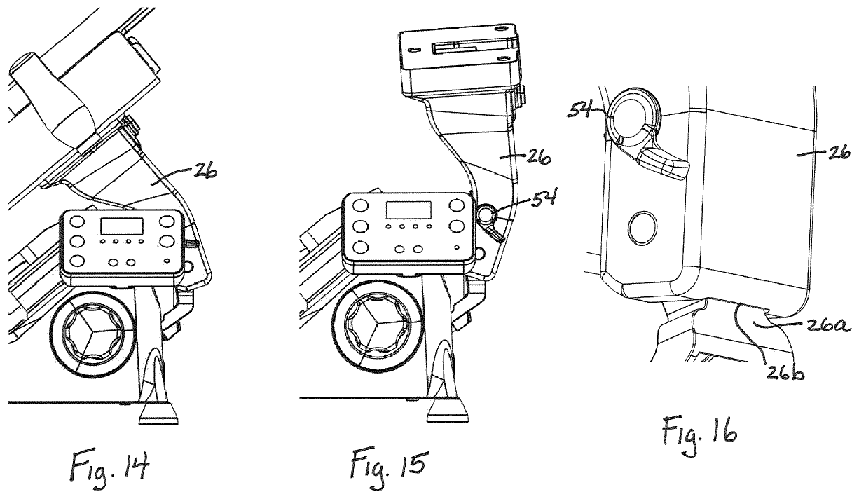

The tray arm 26 is shown in the operating position in FIG. 14 and in the outwardly pivoted cleaning position in FIG. 15. In the cleaning position, per FIG. 16, a lower edge portion 26b of the tray arm 26 interacts with the outer surface of the mount part 26a to limit the outward pivot of the tray arm 26.

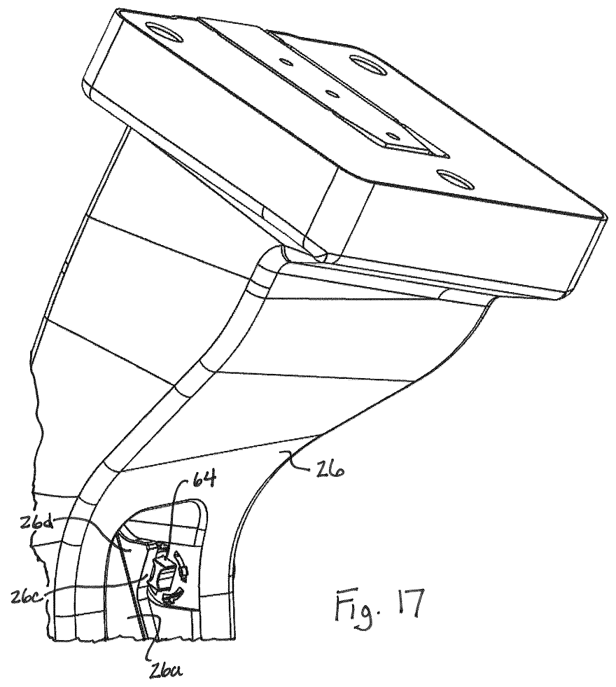

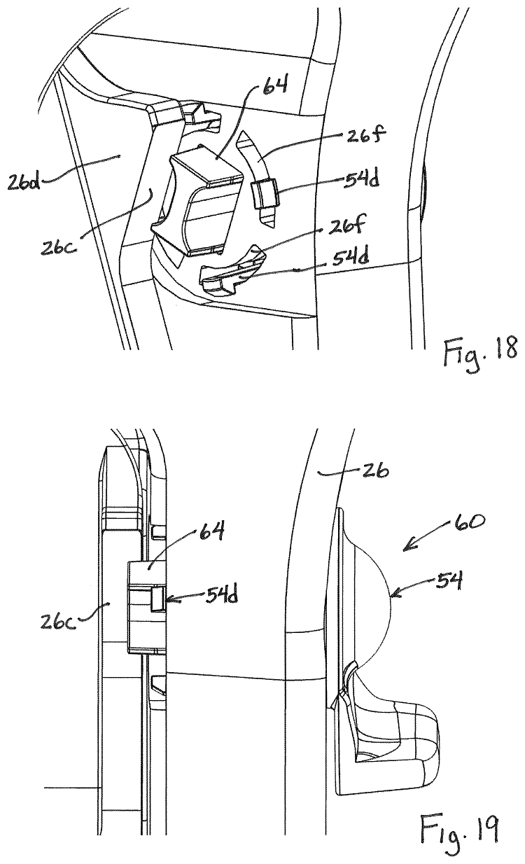

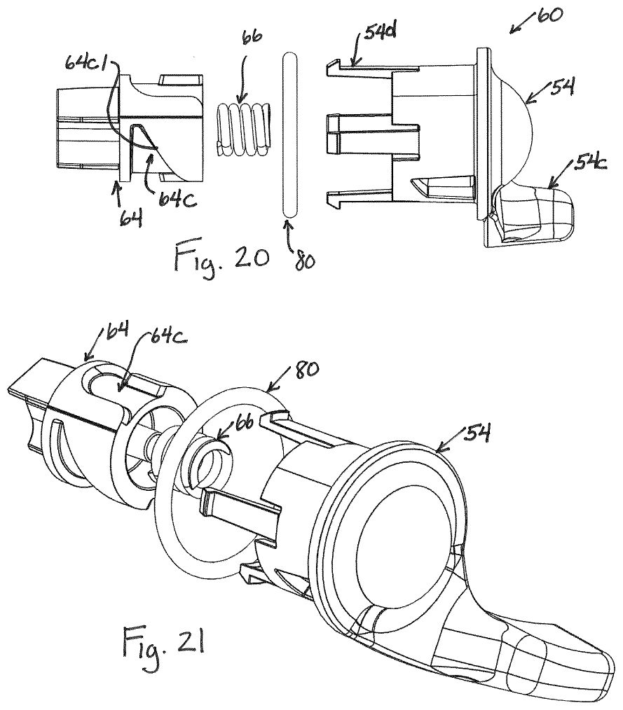

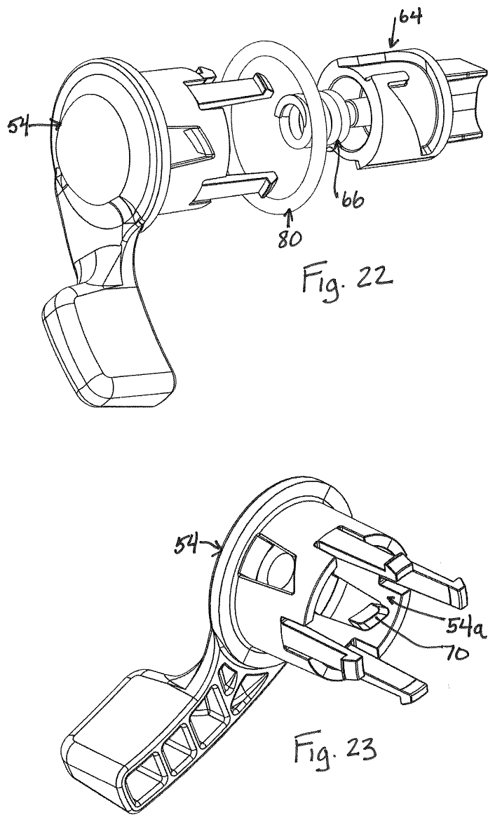

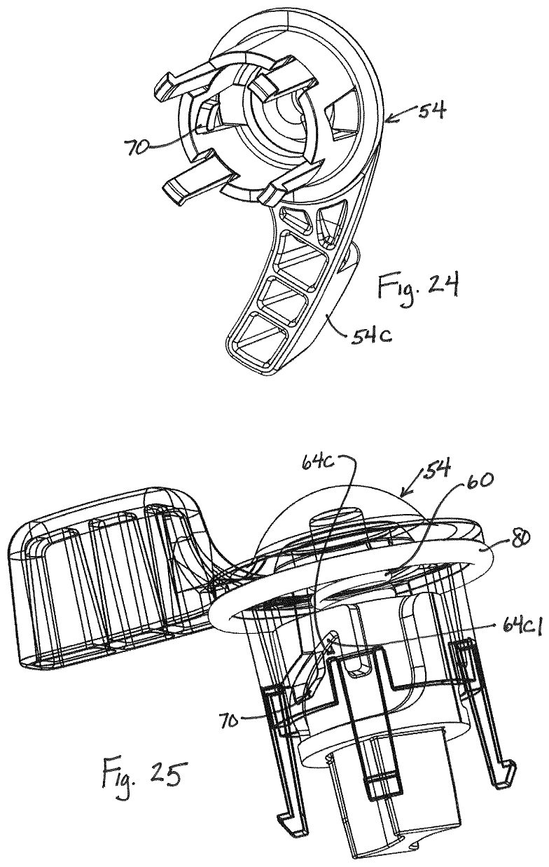

Referring now to FIGS. 17-26, in an alternative embodiment, the mount part 26a does not include a side slot or pocket. Instead, when the mount arm 26 is in the operating position, the distal end of the locking component (again here locking plunger 64) interacts with an edge surface 26c of the mount part 26a. Here, the edge surface 26c is formed by a projection 26d of the mount part. The mount arm 26 includes an opening 26e that is cooperatively shaped with the plunger 64 to help assure proper install orientation, and arcuate latch openings 26f that receive respective clip latch fingers 54d in a manner that allows rotation of the knob 54 by permitting the fingers to move along the openings 26f.

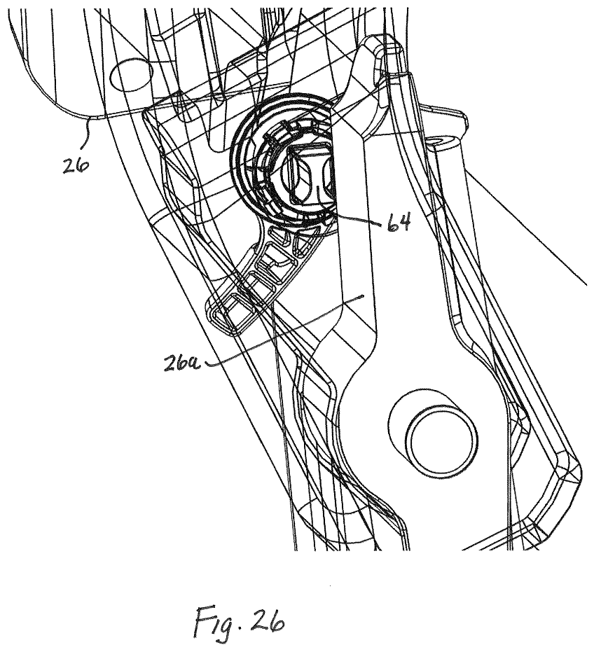

Here, the locking assembly 60 includes the knob 54 (with single arm 54c, cavity 54a and clip latch fingers 54d), locking plunger 64, spring 66 and an O-ring 80 for sealing against an external surface of the mount arm. Helically oriented projecting ribs 70 within the cavity 54a interact with cam surfaces 64c1 of the external recessed regions 64c of the locking plunger to retract the locking plunger toward the knob 54, further into the cavity 54a, against the bias of the spring 66, when the knob 54 is rotated. This enables the locking plunger 64 to clear the edge surface 26c of the mount part 26a, allowing the tray arm 26 to pivot into the cleaning position. As the tray arm pivots from the operating position to the cleaning position, the distal end of the locking plunger 64 rides along a side surface of the mount part 26a, which keeps the locking plunger in the retracted position. Once the tray arm 26 reaches the cleaning position, the locking plunger clears the side surface and the spring moves the locking plunger back into the extended position, such that the locking plunger 64 then interacts with an outer surface portion of the mount part 26a, per FIG. 26 to prevent the tray arm 26 from pivoting back to the cleaning position. To move the tray arm back to the operating position, the knob must again be rotated to retract the locking plunger.

Thus, in this embodiment, when the tray arm 26 is in the operating position, the locking plunger is in a position in which the locking plunger 64 interacts with a portion of the mount part 26 to prevent movement of the tray arm from the operating position to the cleaning position; and, when the tray arm is in the cleaning position, the locking plunger is in a position in which the locking plunger 64 interacts with another portion of the mount part 26 to prevent movement of the tray arm from the cleaning position to the operating position.

The described tray arm locking assemblies may provide various advantages, such as the following.

In embodiments, unlocking the tray arm only takes a partial twist of the knob (e.g., less than 360 degrees of rotation, such as less than 180 degrees of rotation, such as roughly ¼ to ½ a turn). This speeds up machine breakdown and the cleaning process.

In embodiments, the knob is intuitive and implies the direction needed to turn.

In embodiments, the mechanism will automatically lock the tray arm when it is “closed” (when the tray arm is moved to its use or operating position) and/or when the tray arm is “opened” (when the tray arm is moved to is cleaning position).

In embodiments, the locking assembly cannot be partially locked or unlocked.

It is to be clearly understood that the above description is intended by way of illustration and example only and is not intended to be taken by way of limitation. Variations are possible.

1. A food product slicer, comprising:
a base;
a knife mounted for rotation relative to the base;
a carriage assembly mounted to the base for reciprocal movement back and forth past a cutting edge of the knife, wherein the carriage includes a tray atop a tray arm, and the tray arm is pivotably connected to a mount part of a carriage transport;
wherein a releasable locking assembly holds the tray arm in an operating position on the mount part and release of the locking assembly enables the tray arm to pivot to a cleaning position;
wherein the locking assembly is configured such that, when the tray arm is moved from the cleaning position to the operating position, the tray arm locking assembly automatically locks the tray arm to prevent the tray arm from pivoting from the operating position to the cleaning position.

2. The food product slicer of claim 1, wherein the locking assembly comprises a locking plunger movable with the tray arm and, when the tray arm is in the operating position, the locking plunger is in an extended position in which the locking plunger interacts with a portion of the mount part to prevent movement of the tray arm from the operating position to the cleaning position.

3. The food product slicer of claim 2, wherein the locking assembly further comprises a knob rotatably mounted on the tray arm such that a manual rotation of the knob will retract the locking plunger from the extended position to a retracted position clear of the portion of the mount part to allow the tray arm to pivot to the cleaning position.

4. The food product slicer of claim 3, wherein the manual rotation of the knob required to move the locking plunger from the extended position to the retracted position is a rotation of no more than three-hundred and sixty degrees.

5. The food product slicer of claim 3, wherein the locking plunger and the knob include respective interactive cam surfaces that interact during rotation of the knob to move the locking plunger from the extended position to the retracted position.

6. The food product slicer of claim 3, wherein a biasing arrangement is provided such that, upon release of the knob, the locking plunger is urged toward the extended position.

7. The food product slicer of claim 6, wherein the knob includes a cavity into which the locking plunger is moved when in the retracted position.

8. The food product slicer of claim 7, wherein the biasing arrangement comprises a spring within the cavity.

9. The food product slicer of claim 1, wherein the locking assembly is configured such that, when the tray arm is moved from the operating position to the cleaning position, the tray arm locking assembly automatically locks the tray arm to prevent the tray arm from pivoting from the cleaning position to the operating position.

10. The food product slicer of claim 9, wherein the locking assembly comprises a locking component movable with the tray arm and:
when the tray arm is in the operating position, the locking component is in a first position in which the locking component interacts with a first portion of the mount part to prevent movement of the tray arm from the operating position to the cleaning position; and
when the tray arm is in the cleaning position, the locking component is in a second position in which the locking component interacts with a second portion of the mount part to prevent movement of the tray arm from the cleaning position to the operating position.

11. The food product slicer of claim 10, wherein the locking component is movable by rotation of a knob on the tray arm, wherein the locking component is movable between an extended condition and a retracted condition, relative to the knob, and the locking component is in the extended condition when the locking component is in both the first position and the second position.

12. The food product slicer of claim 11, wherein the locking component is biased into the extended condition.

13. The food product slicer of claim 11, wherein the locking component and the knob include respective interactive cam surfaces that interact during rotation of the knob to move the locking component from the extended position to the retracted position.

14. A food product slicer, comprising:
a base;
a knife mounted for rotation relative to the base;
a carriage assembly mounted to the base for reciprocal movement back and forth past a cutting edge of the knife, wherein the carriage includes a tray atop a tray arm, and the tray arm is pivotably connected to a mount part of a carriage transport for movement of the tray arm between an operating position and a cleaning position;
wherein a releasable locking assembly is carried by the tray arm and is configured such that:
when the tray arm is in the operating position, the locking assembly prevents the tray arm from pivoting into the cleaning position; and
when the tray arm is in the cleaning position, the locking assembly prevents the tray arm from pivoting into the operating position.

15. The food product slicer of claim 14, wherein the locking assembly comprises a locking component movable with the tray arm and:
when the tray arm is in the operating position, the locking component is in a first position in which the locking component interacts with a first portion of the mount part to prevent movement of the tray arm from the operating position to the cleaning position; and
when the tray arm is in the cleaning position, the locking component is in a second position in which the locking component interacts with a second portion of the mount part to prevent movement of the tray arm from the cleaning position to the operating position.

16. The food product slicer of claim 14, wherein the locking assembly includes a rotatable knob, and the locking component is a locking plunger that is biased away from the knob by a spring.

17. The food product slicer of claim 16, wherein interacting surface portions of the knob and the locking plunger pull the locking plunger toward the knob when the knob is rotated.

18. A food product slicer, comprising:
a base;
a knife mounted for rotation relative to the base;
a carriage assembly mounted to the base for reciprocal movement back and forth past a cutting edge of the knife, wherein the carriage includes a tray atop a tray arm, and the tray arm is pivotably connected to a mount part of a carriage transport for movement of the tray arm between an operating position and a cleaning position;
wherein a releasable locking assembly is carried by the tray arm and is configured to hold the tray arm in the operating position, wherein the locking assembly includes a rotatable knob and a locking component that is biased away from the knob by a spring.

19. The food product slicer of claim 18, wherein interacting surface portions of the knob and the locking component pull the locking component toward the knob when the knob is rotated.
